(19) United States
(12) Patent Application Publication
(10) Pub. No.: US 2010/0112448 A1
(43) Pub. Date: May 6, 2010

(54) POSITIVE ELECTRODE ACTIVE MATERIAL FOR LITHIUM SECONDARY BATTERY AND METHOD OF MANUFACTURING THE SAME

(75) Inventors: Denis Yau Wai Yu, Kobe-shi (JP); Katsunori Yanagida, Kobe-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/609,858

(22) Filed: Oct. 30, 2009

(30) Foreign Application Priority Data
Oct. 31, 2008 (JP) 2008-281719
Mar. 30, 2009 (JP) 2009-082779

(51) Int. Cl. H01M 4/50

(52) U.S. Cl. 429/224

(57) ABSTRACT

A positive electrode active material includes a layered lithium-manganese oxide represented by the general formula Li₂₋ₓMn_{1-y}O₃₋ₚ, where 0≦x≦2/3, 0≦y≦1/3, and 0≦p≦1, the lithium-manganese oxide having a full width half maximum of a peak of the (001) crystal plane, as determined by an X-ray diffraction analysis, of 0.22° or greater, and an average particle size of 130 nm or less.

### BACKGROUND OF THE INVENTION

1. Field of the Invention

The present invention relates to a positive electrode active material for lithium secondary batteries that comprises a lithium-manganese oxide having a layered structure. The invention also relates to a method of manufacturing the active material.

2. Description of Related Art

### REFERENCES

[Patent Document 1] Japanese Published Unexamined Patent Application No. 2000-223122

[Patent Document 2] Japanese Published Unexamined Patent Application No. 5-151970

[Patent Document 3] U.S. Pat. No. 6,960,335

[Patent Document 4] U.S. Pat. No. 5,153,081

[Patent Document 5] U.S. Pat. No. 7,211,237

[Non-patent Document 1] A. R. Armstrong, A. D. Robertson, and P. G. Bruce, J. Power Sources, 146, 275 (2005).

[Non-patent Document 2] S. H. Kim, S. J. Kim, K. S, Nahm, H. T. Chung, Y. S. Lee, and J. Kim, J. Alloys Compounds 449, 339 (2008).

[Non-patent Document 3] Y. S. Hong, Y. J. Park, K. S. Ryu, and S. H. Chang, Solid State Ionics 176, 1035 (2005).

[Non-patent Document 4] C. S. Johnson, N. Li, J. T. Vaughey, S. A. Hackney, and M. M. Thackeray, Electrochem. Comm. 7, 528 (2005).

Lithium-manganese oxide represented as Li₂MnO₃ or Li[Li_{0.33}Mn_{0.67}]O₂ is a layered material. Since the valency of manganese is 4⁺ in this material, it was previously believed that Li⁺ ions cannot be released during charge. Non-patent Document 1 reports that this material becomes electrochemically active when charged to 4.5 V (vs. Li/Li⁺). According to Non-patent Document 1, these materials are prepared by causing Li₂CO₃ and MnCO₃ to undergo a solid-phase reaction at 500° C. for 40 hours. A charge capacity of 199 mAh/g and a discharge capacity of about 120 mAh/g are obtained by these materials.

Non-patent Document 2 reports that Li_{1.296}Ni_{0.056}Mn_{0.648}O₂ having an initial discharge capacity of 110 mAh/g was synthesized by preparing a Ni—Mn precursor in an aqueous solution and annealing the precursor with LiOH at 800° C. Non-patent Document 3 reports that the material is manufactured by annealing Li₂MnO₃ having a particle size of 0.5 μm at 900° C. for 5 hours, but the material has a discharge capacity of only 100 mAh/g.

Non-patent Document 4 reports that Li₂MnO₃ having a charge capacity of 383 mAh/g at 5 V (vs. Li/Li⁺) and a discharge capacity of 208 mAh/g at 2 V (vs. Li/Li⁺) is manufactured at 500° C.

As described above, the conventional materials represented as Li[Li_{0.33}Mn_{0.67}]O₂ have a discharge capacity of 210 mAh/g or lower. However, if 1 equivalent of Li can be reversibly intercalated and deintercalated, the theoretical capacity will be 344 mAh/g, and if 0.67 equivalent Li can be reversibly intercalated and deintercalated, the capacity will be about 230 mAh/g. This means that the lithium-manganese oxides represented as Li₂MnO₃ and Li[Li_{0.33}Mn_{0.67}]O₂ have a possibility of achieving a higher discharge capacity. As will be described later, the present invention specifies the full width half maximum of the peak of the (001) crystal plane, as determined by an X-ray diffraction analysis, and the average particle size of the lithium-manganese oxide as described above.

Patent Document 1 discloses a lithium-nickel-manganese composite oxide having a full width half maximum of a peak in the range of 2θ=18.71±0.25°, as determined by an X-ray diffraction analysis, of 0.15° to 0.22°. The document describes that the use of such a lithium-nickel-manganese composite oxide enables construction of a lithium secondary battery that exhibits improved cycle performance and load characteristics.

Patent Document 2 discloses a lithium-manganese oxide formed by annealing a source material (precursor) mixture of lithium and manganese at 470° C. to 600° C. and quenching the material, the lithium-manganese oxide having a full width half maximum of a diffraction peak at a diffraction angle of 18.6°, as determined by X-ray diffraction, of from 0.29° to 0.44°. However, this lithium-manganese oxide has a Li:Mn ratio of 1:2, which corresponds to a spinel-type lithium-manganese oxide. In this respect, this lithium-manganese oxide is different from the layered lithium-manganese oxide of the present invention.

Patent Document 3 discloses a layered lithium-manganese oxide having a particle size of from about 5 nm to about 300 nm. Patent Document 3 describes that the capacity retention ratio of the layered lithium-manganese oxide can be improved by making the size of the crystal smaller.

The lithium-manganese oxide in Patent Document 3 is produced by preparing a Na-based compound and thereafter ion-exchanging with Li.

Patent Document 4 discloses a method of manufacturing a layered Li—Mn oxide having a Li/Mn ratio of 1.8 to 2.2 by treating Li₂MnO₃ with an acid. In Example 1 of the publication, LiOH and γ-MnO₂ having an average particle size of less than 50 μm are used to produce Li₂MnO₃. The precursor is annealed at 400° C. for 18 days (at 700° C. for 24 hours) to produce a single phase Li₂MnO₃.

Patent Document 5 describes that precursors of Co, Mn, Ni, and Li are pulverized preferably in water to prepare a mixture of well-distributed precursors having an average particle size of 0.3 μm or less so that a material represented by the formula LiₓM_{y}O₂ (x=0 to 1.2) is produced, and the material is annealed at 900° C. to produce the end product. The particle size of the end product is not mentioned.

### BRIEF SUMMARY OF THE INVENTION

It is an object of the present invention to provide a positive electrode active material for lithium secondary batteries that is a layered lithium-manganese oxide and has a high discharge capacity. It is also an object of the invention to provide a method of manufacturing such a positive electrode active material.

The present invention provides a positive electrode active material for lithium secondary batteries, comprising a layered lithium-manganese oxide represented by the general formula Li₂₋ₓMn_{1-y}O₃₋ₚ, where 0≦x≦2/3, 0≦y≦1/3, and 0≦p≦1, the lithium-manganese oxide having a full width half maximum of a peak of the (001) crystal plane, as determined by an X-ray diffraction analysis, of 0.22° or greater, and an average particle size of 130 nm or less.

The lithium-manganese oxide in the present invention has a full width half maximum of the peak of the (001) crystal plane, as determined by an X-ray diffraction analysis, of 0.22° or greater. The full width half maximum of the peak in an X-ray diffraction analysis correlates with crystallinity, and the greater the full width half maximum is, the lower the crystallinity.

In the present invention, the full width half maximum of the peak of the (001) crystal plane as determined by an X-ray diffraction analysis is 0.22° or greater, so the positive electrode active material has a low crystallinity and a structural instability in the crystal. As a result, it is believed that lithium is easily released from the active material, and the discharge capacity is increased. Moreover, the lithium-manganese oxide in the present invention has an average particle size of 130 nm or less. This means that the diffusion path of the lithium in the active material particle is short. As a result, it is believed that lithium is released more easily from the active material, and the discharge capacity can be increased.

The lithium-manganese oxide in the present invention is a layered lithium-manganese oxide represented by the formula Li₂₋ₓMn_{1-y}O₃₋ₚ, where 0≦x≦2/3, 0≦y≦1/3, and 0≦p≦1. More preferably, x, y and p in the formula are: 0≦x≦0.3, 0≦y≦0.3, and 0≦p≦0.1; or 0≦x≦0.2, 0≦y≦0.2, and 0≦p≦0.1.

Examples of the lithium-manganese oxide in the present invention include ones represented as Li₂MnO₃ or Li[Li_{0.33}Mn_{0.67}]O₂.

In the lithium-manganese oxide of the present invention, the manganese (Mn) sites may be substituted by at least one additional element M. Examples of the additional element M include at least one element selected from the group consisting of Al, B, Ti, Mg, Co, Ni and Fe.

In the lithium-manganese oxide of the present invention, the oxygen (O) sites may be substituted by fluorine (F).

In the case of the additional element M or F is contained, the lithium-manganese oxide may be the one represented by the general formula Li₂₋ₓMn_{1-y}M_{z}O₃₋ₚF_{q}, where 0≦x≦0.3, 0≦y≦0.3, 0≦z≦0.5, 0≦p≦0.1, and 0≦q≦0.1, and the additional element M is at least one element selected from the group consisting of Al, B, Ti, Mg, and Co.

When the additional element is added to the lithium-manganese oxide, the crystallinity can be lowered so that the discharge capacity can be further increased.

When the additional element is Al, Ti, B or Mg, it is preferable that the parameter z in the general formula be in the range 0≦z≦0.1.

When the additional element is Co, it is preferable that the parameter z in the general formula be in the range 0<z≦0.5, because Co is an electrochemically active additional element and can contribute to charge and discharge.

When the oxygen (O) sites are substituted by fluorine (F), a high capacity can be obtained because fluorine forms a surface film that protects the active material. From this viewpoint, the parameter q in the general formula is within the range 0≦q≦0.1.

In the present invention, it is more preferable that the full width half maximum of the peak of the (001) crystal plane, as determined by an X-ray diffraction analysis, be 0.30° or greater. By setting this range, the discharge capacity can be further increased. Although the upper limit of the full width half maximum is not particularly limited, it is generally preferable that the upper limit be 0.44° or less.

In the present invention, it is more preferable that the lithium-manganese oxide have an average particle size of 90 nm or less. In this range, the discharge capacity can be further increased. Although the lower limit of the average particle size is not particularly limited, it is generally preferable that the lower limit be 50 nm or greater. The average particle size may be determined by observing the material with, for example, a scanning electron microscope (SEM). Generally, the average particle size can be obtained by measuring particle sizes of about 60 particles and averaging them.

It is preferable that the lithium-manganese oxide in the present invention have a BET specific surface area of 9 m²/g or greater, more preferably 15 m²/g or greater. In this range, the discharge capacity can be further increased.

The present invention also provides a method of manufacturing the positive electrode active material for lithium secondary batteries according to the present invention, comprising: using a lithium-containing precursor and a manganese-containing precursor each having a reaction temperature of 500° C. or lower and, when necessary, an additional element-containing precursor, and producing the positive electrode active material by a solid phase method.

Examples of the lithium-containing precursor having a reaction temperature of 500° C. or lower include lithium hydroxide (melting point 471° C.) and lithium nitrate (melting point 261° C.).

Examples of the manganese-containing precursor having a reaction temperature of 500° C. or lower include manganese carbonate (decomposition temperature 350° C.).

By producing the lithium-manganese oxide by a solid phase method using the lithium-containing precursor and the manganese-containing precursor each having a reaction temperature of 500° C. or lower and, when necessary, the additional element-containing precursor, the lithium-manganese oxide of the present invention can be manufactured through annealing at a low temperature. Thus, the lithium-manganese oxide can be manufactured more easily and efficiently.

The lower limit of the decomposition temperature is not particularly limited, but it is generally 350° C. or higher.

It is preferable that the lithium-containing precursor, the manganese-containing precursor, and, when necessary, the additional element-containing precursor that are used in the manufacturing method of the present invention be pulverized in a solvent. It is preferable that the solvent be an organic solvent since the lithium-containing precursor and the manganese-containing precursor are in many cases soluble in water. Examples of the organic solvent include acetone, methanol, ethanol, N-methyl-2-pyrrolidone (NMP). Acetone is particularly preferable. Acetone has affinity with water; therefore, if a hydroxide is used as a precursor, it bonds with water molecules in the mixing step and allows the precursor to be blended finely.

A preferable example of the method of the pulverization is pulverization with a mill. An example of the mill is a ball mill.

In the present invention, it is preferable that the annealing temperature for the lithium-containing precursor, the manganese-containing precursor, and, when necessary, the additional element-containing precursor, be 400° C. or higher. It is more preferable that the annealing temperature be within the range of from 400° C. to 800° C. Generally, the annealing time is from 8 hours to 48 hours.

A lithium secondary battery according to the present invention may include a negative electrode, a non-aqueous electrolyte, and a positive electrode containing the positive electrode active material according to the invention.

The lithium secondary battery according to the present invention employs the positive electrode active material comprising the lithium-manganese oxide of the present invention, and therefore has an improved discharge capacity.

The negative electrode active material used for the negative electrode in the lithium secondary battery of the present invention may be any material as long as it is capable of intercalating and deintercalating lithium. Examples include: metallic lithium; lithium alloys such as lithium-aluminum alloy, lithium-silicon alloy, and lithium-tin alloy; carbon materials such as graphite, coke, and annealed organic materials; and metal oxides such as SnO₂, SnO, and TiO₂, which show a lower potential than the positive electrode active material.

The solvent of the non-aqueous electrolyte in the lithium secondary battery of the invention is not particularly limited. Examples of the solvent include cyclic carbonic esters such as ethylene carbonate, propylene carbonate, 1,2-butylene carbonate, and 2,3-butylene carbonate; cyclic esters such as γ-butyrolactone and propane sultone; chain carbonic esters such as methyl ethyl carbonate, diethyl carbonate, and dimethyl carbonate; chain ethers such as 1,2-dimethoxyethane, 1,2-diethoxyethane, diethyl ether, and ethyl methyl ether; as well as methyl acetate, ethyl acetate, propyl acetate, methyl propionate, ethyl propionate, tetrahydrofuran, 2-methyltetrahydrofuran, 1,4-dioxane, and acetonitrile.

The lithium salt contained in the non-aqueous electrolyte of the lithium secondary battery according to the present invention may be a lithium salt commonly used in the lithium-ion secondary battery. Examples include LiPF₆, LiAsF₆, LiBF₄, LiCF₃SO₃, LiN(C_{I}F_{2I+1}SO₂)(CₘF₂ₘ₊₁SO₂) (where 1 and m are integers equal to or greater than 1), and LiC(CₚF₂ₚ₊₁SO₂)(C_{q}F_{2q+1}SO₂)(CᵣF_{2q+1}SO₂) (where p, q, and r are integers equal to or greater than 1). These lithium salts may be used alone or in combination. It is preferable that the content of the lithium salt be within the range of from 0.1 mole/liter to 1.5 mole/liter, more preferably within the range of from 0.5 mole/liter to 1.5 mole/liter, in the non-aqueous electrolyte.

The present invention makes available a positive electrode active material for lithium secondary batteries comprising a layered lithium-manganese oxide that shows a high discharge capacity.

The manufacturing method of the present invention makes it possible to manufacture the lithium-manganese oxide of the present invention more easily and efficiently.

### BRIEF DESCRIPTION OF THE DRAWINGS

FIG. 1 is a graph illustrating discharge profiles for the first cycle;

FIG. 2 is a graph illustrating the relationship between annealing temperature and discharge capacity;

FIG. 3 is a graph illustrating X-ray diffraction profiles of lithium-manganese oxides;

FIG. 4 is a graph illustrating the relationship between the full width half maximum of the peak of a (001) crystal plane and the discharge capacity;

FIG. 5 is a scanning electron micrograph showing a lithium-manganese oxide of Example 3 according to the present invention;

FIG. 6 is a scanning electron micrograph showing a lithium-manganese oxide of Example 5 according to the present invention;

FIG. 7 is a scanning electron micrograph showing a lithium-manganese oxide of Comparative Example 2 according to the present invention;

FIG. 8 is a scanning electron micrograph showing a lithium-manganese oxide of Comparative Example 3 according to the present invention;

FIG. 9 is a graph illustrating the relationship between discharge capacity versus average particle size and BET specific surface area;

FIG. 10 is a graph illustrating discharge profiles for the first cycle;

FIG. 11 is a graph illustrating the X-ray diffraction profiles of Comparative Examples 4 and 5;

FIG. 12 is a graph illustrating the discharge profiles for the first cycle of Comparative Examples 4 and 5; and

FIG. 13 is a graph illustrating the relationship between the full width half maximum of the peak of a (001) crystal plane and the discharge capacity.

### DETAILED DESCRIPTION OF THE INVENTION

Hereinbelow, the present invention is described in further detail based on examples thereof. It should be construed, however, that the present invention is not limited to the following examples but various changes and modifications are possible without departing from the scope of the invention.

### EXPERIMENT 1

### Examples 1 to 5 and Comparative Examples 1 to 3

### Preparation of Positive Electrode Active Material

Lithium hydroxide (LiOH.H₂O) and manganese carbonate (MnCO₃.nH₂O (n: about 0.5)) were mixed so that the mole ratio of Li:Mn became 2:1. The mixture was added in acetone and pulverized in acetone for 1 hour using a ball mill. The mixture was added so that the total concentration of lithium hydroxide and manganese carbonate in acetone became 60 weight % to perform the pulverization with the ball mill. Thereafter, the mixture was dried at 60° C. to volatilize acetone, and the pulverized mixture was annealed, without being pelletized, under the annealing conditions set forth in Table 1. As shown in Table 1, the annealing was performed under the following conditions: at 400° C. for 48 hours (Example 1), at 425° C. for 10 hours (Example 2), at 600° C. 10 hours (Example 3), at 750° C. 10 hours (Example 4), at 800° C. for 10 hours (Example 5), at 850° C. for 10 hours (Comparative Example 1), at 900° C. for 10 hours (Comparative Example 2), and at 1000° C. for 10 hours (Comparative Example 3).

Lithium-manganese oxides represented as Li[Li_{0.33}M_{n0.67}]O₂ were prepared in the above-described manner.

### Measurement of the Full Width Half Maximum of a Peak by an X-Ray Diffraction Analysis

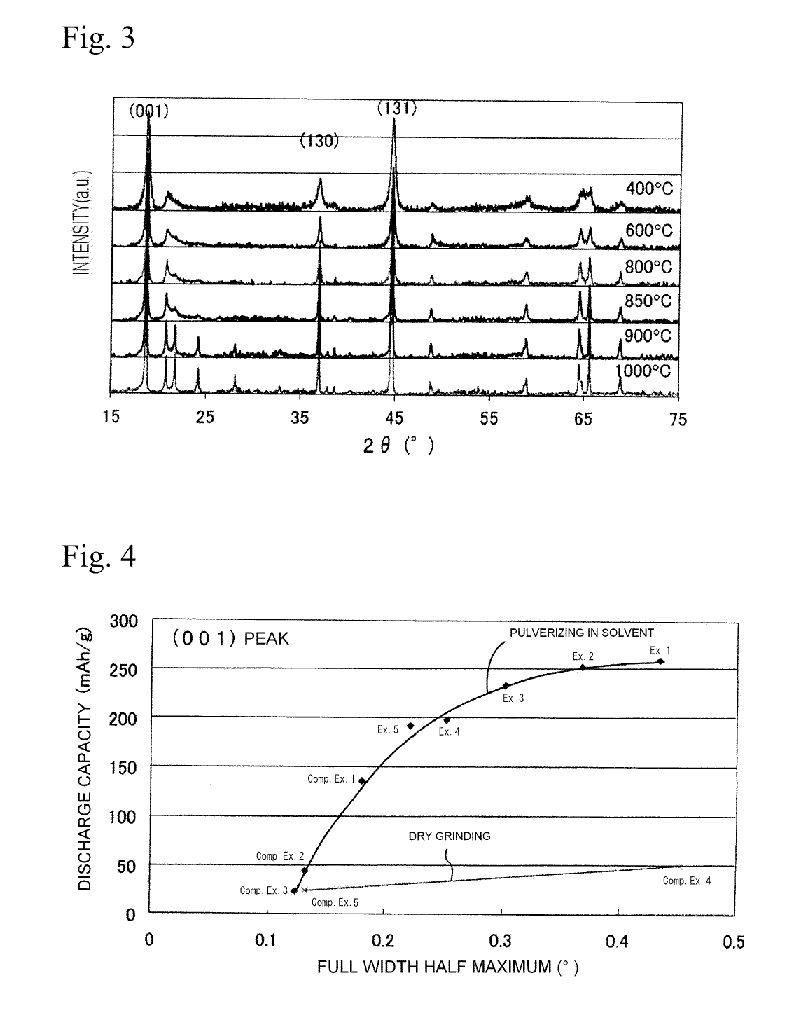

The X-ray diffraction profiles of the resultant lithium-manganese oxides were measured. The X-ray diffraction profiles of the lithium-manganese oxides annealed at 400° C., 600° C., 800° C., 850° C., 900° C., and 1000° C. are shown in FIG. 3. The X-ray diffraction was measured using CuKα radiation.

The full width half maximum s of the peak of the (001) crystal plane, i.e., the peak at about 18.7°, were measured. The results are shown in Table 1 below.

### Measurement of Average Particle Size

The average particle sizes of the resultant lithium-manganese oxides were determined by SEM observation. The results of the measurement are shown in Table 1 below.

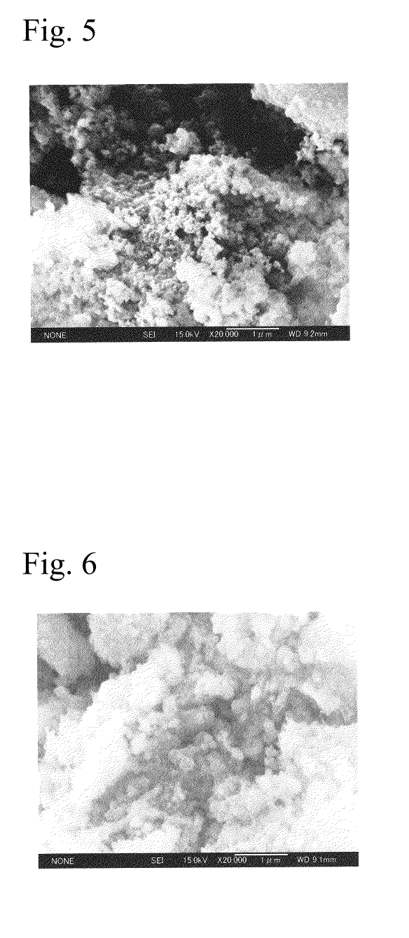

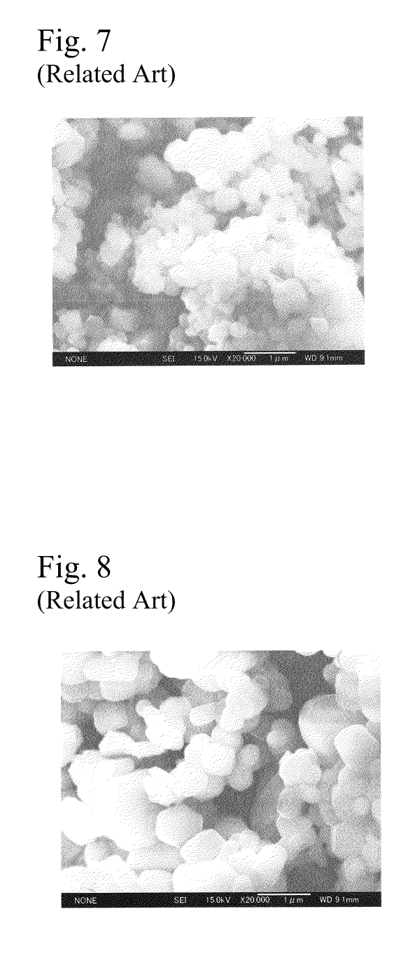

FIG. 5 shows the lithium-manganese oxide of Example 3, which was annealed at 600° C., and FIG. 6 shows the lithium-manganese oxide of Example 5, which was annealed at 800° C. FIG. 7 shows the lithium-manganese oxide of Comparative Example 2, which was annealed at 900° C., and FIG. 8 shows the lithium-manganese oxide of Comparative Example 3, which was annealed at 1000° C.

As clearly seen from the results shown in Table 1 and FIGS. 5 to 8, it is understood that the higher the annealing temperature is, the greater the average particle size.

### Measurement of BET Specific Surface Area

The BET specific surface areas of the resultant lithium-manganese oxides were measured. The BET specific surface area was measured using a nitrogen absorption method. The results of the measurement are shown in Table 1 below.

The results shown in Table 1 demonstrate that the greater the average particle size is, the smaller the BET specific surface area.

### Preparation of Positive Electrode

Positive electrodes were prepared using the obtained lithium-manganese oxides. 10 weight % carbon material as a conductive agent and 10 weight % polyvinylidene fluoride as a binder were mixed together with the lithium-manganese oxide, and this was added in a N-methyl-2-pyrrolidone solution, to prepare a positive electrode mixture slurry. The resultant positive electrode mixture slurry was applied onto an aluminum foil, and then dried, to prepare a positive electrode.

### Preparation of Non-Aqueous Electrolyte Solution

Lithium hexafluorophosphate (LiPF₆) was dissolved at a concentration of 1 mole/L in a mixed non-aqueous solvent of 3:7 volume ratio of ethylene carbonate (EC) and diethyl carbonate (DEC), whereby a non-aqueous electrolyte solution was prepared (1 M LiPF₆ EC/DEC (3/7)).

### Preparation of Lithium Secondary Battery

Lithium secondary batteries were fabricated using the positive electrodes and the non-aqueous electrolyte solution prepared in the foregoing manner. Each of the lithium secondary batteries was a three-electrode cell. The three-electrode cell was prepared using the positive electrode prepared in the above-described manner as the working electrode, metallic lithium as the counter electrode and the reference electrode, and the non-aqueous electrolyte solution prepared in the above-described manner.

The batteries were discharged between 4.8 V and 2 V at a constant current of 10 mA/g, to determine discharge capacities. The discharge capacities at the first cycle are shown in Table 1 below.

TABLE 1

| | | | full width half | BET specific | Average | Discharge |
|---|---|---|---|---|---|---|
| | | | maximum of peak | surface area | particle | capacity |
| | Pulverization | Annealing | at 18.7° (001) | (m²/g) | size (nm) | (mAh/g) |
| Ex. 1 | Pulverized in | 400° C., 48 hrs. | 0.434° | 20.2 | 72 | 258.7 |
| | solvent | | | | | |
| Ex. 2 | Pulverized in | 425° C., 10 hrs. | 0.368° | 18.0 | 69 | 251.8 |
| | solvent | | | | | |
| Ex. 3 | Pulverized in | 600° C., 10 hrs. | 0.302° | 15.9 | 87 | 232.4 |
| | solvent | | | | | |
| Ex. 4 | Pulverized in | 750° C., 10 hrs. | 0.252° | 10.7 | 105 | 197.2 |
| | solvent | | | | | |
| Ex. 5 | Pulverized in | 800° C., 10 hrs. | 0.221° | 9.0 | 130 | 191.6 |
| | solvent | | | | | |
| Comp. | Pulverized in | 850° C., 10 hrs. | 0.180° | 6.6 | 142 | 138.4 |
| Ex. 1 | solvent | | | | | |
| Comp. | Pulverized in | 900° C., 10 hrs. | 0.132° | 2.2 | 392 | 43.8 |
| Ex. 2 | solvent | | | | | |
| Comp. | Pulverized in | 1000° C., 10 hrs. | 0.123° | 1.5 | 650 | 22.7 |
| Ex. 3 | solvent | | | | | |

FIG. 1 is a graph showing the discharge profiles at the first cycle of the batteries that use the lithium-manganese oxides obtained by annealing at 400° C. (Example 1), 600° C. (Example 3), 800° C. (Example 5), 850° C. (Comparative Example 1), 900° C. (Comparative Example 2), and 1000° C. (Comparative Example 3) as the positive electrode active material.

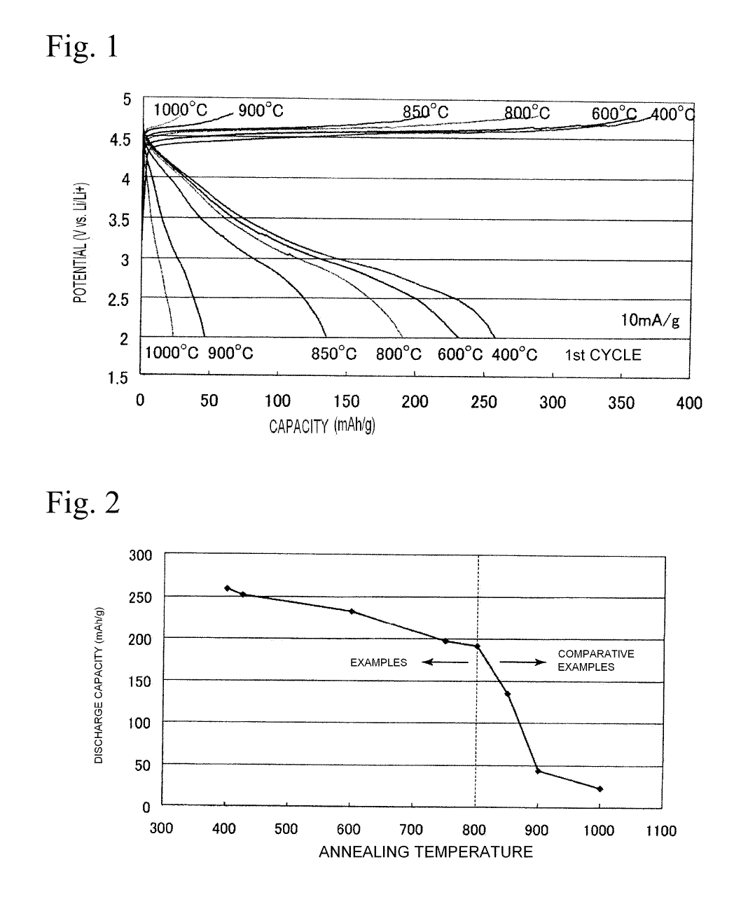

FIG. 2 is a graph illustrating the relationship between annealing temperature and discharge capacity.

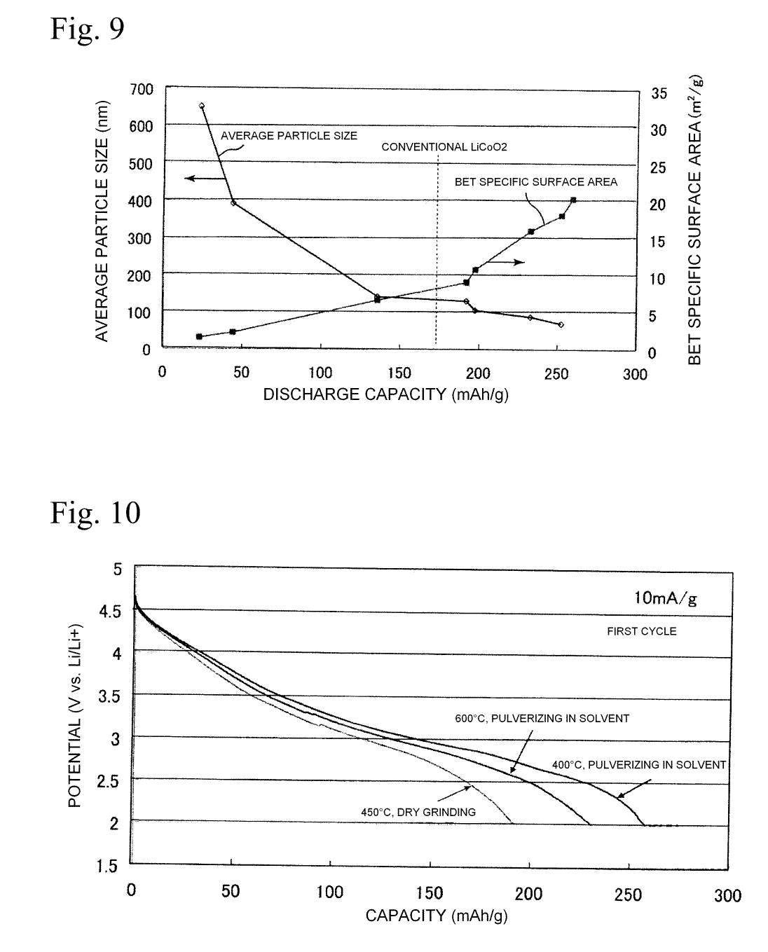

FIG. 9 is a graph illustrating the relationship between discharge capacity versus average particle size or BET specific surface area. In FIG. 9, “conventional LiCoO₂” represents a typical conventional discharge capacity obtained when using lithium cobalt oxide as the positive electrode active material.

As clearly seen from the results shown in FIGS. 2 and 9, Examples 1 to 5, which have a full width half maximum of the peak of the (001) crystal plane peak of 0.22° or greater, as determined by an X-ray diffraction analysis, and have an average particle size of 130 nm or less according to the present invention, achieved higher discharge capacities than Comparative Examples 1 to 3, which fall outside of range of the present invention. This is believed to be that when the full width half maximum of the peak of the (001) crystal plane is 0.22° or greater, the positive electrode active material has a low crystallinity and structural instability, so lithium ions are easily released. In addition, the fact that the average particle size is 130 nm or less means that the lithium diffusion path in the active material particle is short. As a result, it is believed that lithium ions are more easily released and a higher discharge capacity can be obtained.

It should be noted that when the BET specific surface area is 9 m²/g or greater, the discharge capacity improves.

Moreover, Examples 1 to 3, each of which has a full width half maximum of the peak of the foregoing crystal plane of 0.30° or greater and an average particle size of 90 nm or less, achieved higher discharge capacities than Examples 4 and 5. This demonstrates that the discharge capacity can be increased further when the full width half maximum is set at 0.30° or greater and the average particle size is set at 90 nm or less. It is also demonstrated that the discharge capacity can be increased further when the BET specific surface area is set at 15 m²/g or greater.

### Example 6

A lithium-manganese oxide was prepared in the same manner as described in Examples 1 to 5, except that the lithium hydroxide and manganese carbonate identical to those used in Example 1 were mixed and dry ground in a mortar and that the mixture was annealed at 450° C. for 10 hours.

The full width half maximum of the peak of the (001) crystal plane, the average particle size, and the BET specific surface area of the resultant lithium-manganese oxide were measured in the same manner as described above. The results are shown in Table 2 below.

In addition, using the resultant lithium-manganese oxide, a positive electrode was prepared in the same manner as described in Examples 1 to 5 above, and using the prepared positive electrode, a lithium secondary battery was fabricated. The discharge capacity of the lithium secondary battery was measured in the same manner as described above. The result is shown in Table 2 below. In Table 2, it was confirmed that the BET specific surface area was 9 m²/g or greater, although the specific value was not determined.

TABLE 2

| | | | full width | | | |
|---|---|---|---|---|---|---|
| | | | half | | Average | |
| | | | maximum | BET specific | particle | Discharge |
| | | | of peak at | surface area | size | capacity |
| | Pulverization | Annealing | 18.7° (001) | (m²/g) | (nm) | (mAh/g) |
| Ex. 6 | Dry grinding | 450° C., 10 hrs. | 0.234° | 9 or greater | 121 | 191.9 |

FIG. 10 is a graph showing the discharge profiles at the first cycle of Example 6, which was prepared by dry grinding and annealing at 450° C., Example 1, which was prepared by pulverizing in the solvent and annealing at 400° C., and Example 3, which was prepared by pulverizing in the solvent and annealing at 600° C.

As clearly seen from FIG. 10, Example 6, which was prepared by dry grinding, showed a lower discharge capacity than Examples 1 and 3, which were prepared by pulverizing in a solvent. This indicates that pulverizing in a solvent can yield a lithium-manganese oxide having an even higher discharge capacity.

### Comparative Examples 4 and 5

Lithium hydroxide (LiOH) and manganese oxide (γ-MnO₂) were used as the source materials (precursors) for preparing a lithium-manganese oxide, and these were dry blended in a mortar. The resultant mixture was annealed at 400° C. for 18 days (Comparative Example 4) or at 700° C. for 24 hours (Comparative Example 5), to prepare lithium-manganese oxides. This manufacturing method corresponds to the manufacturing method disclosed in Patent Document 4.

The full width half maximum of the peak of the (001) crystal plane, the average particle size, and the BET specific surface area of the resultant lithium-manganese oxides were measured in the same manner as described above. The results are shown in Table 3 below.

In addition, using the resultant lithium-manganese oxides, lithium secondary batteries were fabricated, and their discharge capacities at the first cycle were measured. The results of the measurement are shown in Table 3 below.

TABLE 3

| | | | full width | | | |
|---|---|---|---|---|---|---|
| | | | half | | Average | |
| | | | maximum | BET specific | particle | Discharge |
| | | | of peak at | surface area | size | capacity |
| | Pulverization | Annealing | 18.7° (001) | (m²/g) | (nm) | (mAh/g) |
| Comp. | Dry grinding | 400° C., 18 days | 0.452° | 2.7 | 206 | 49.1 |
| Ex. 4 | | | | | | |
| Comp. | Dry grinding | 700° C., 24 hrs. | 0.132 | 1.4 | 319 | 23.4 |
| Ex. 5 | | | | | | |

FIG. 11 is a graph illustrating the X-ray diffraction profiles of Comparative Examples 4 and 5.

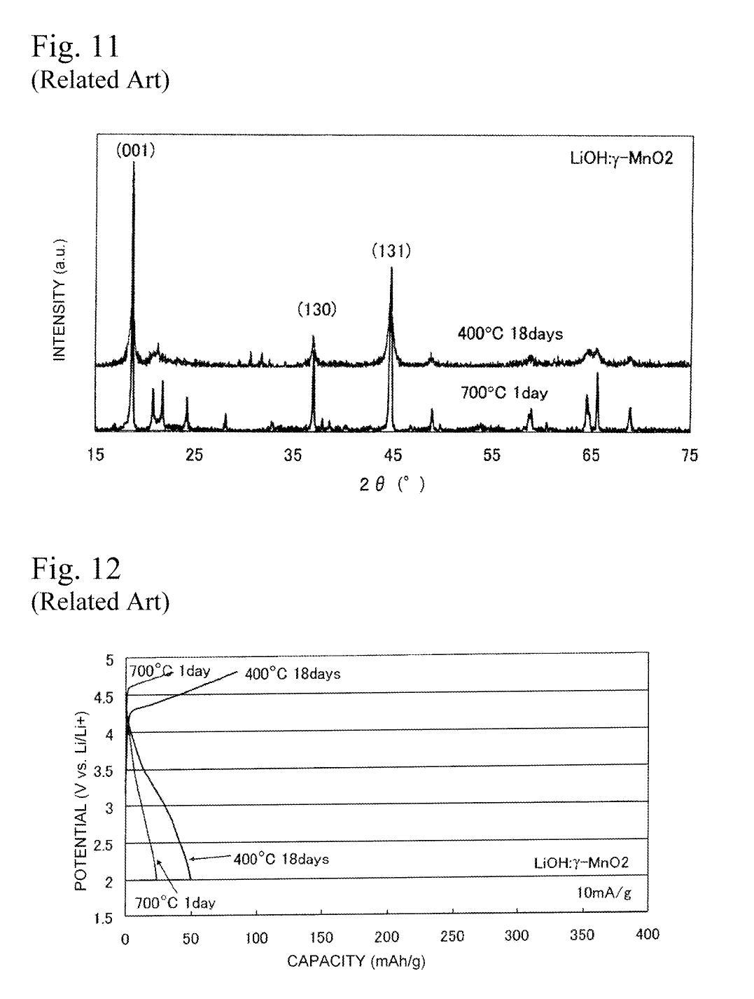

FIG. 12 is a graph illustrating their discharge profiles for the first cycle.

As is clear from Table 3 and FIGS. 11 and 12, although the lithium-manganese oxide of Comparative Example 4 has a full width half maximum of the peak of the (001) crystal plane of 0.22° or greater, it has an average particle size of 130 nm or greater, so it falls outside the scope of the lithium-manganese oxide according to the present invention. Comparative Example 5 falls outside the scope of the present invention in terms of both the full width half maximum of the peak of the (001) crystal plane and the average particle size.

The lithium-manganese oxides of Comparative Examples 4 and 5, which are outside the scope of the present invention, show significantly lower discharge capacities than those of Examples 1 to 5, which are shown in Table 1. Thus, they cannot achieve a high discharge capacity.

FIG. 4 also shows the results of the full width half maximum and discharge capacity of Comparative Examples 4 and 5. As clearly seen from FIG. 4, a lithium-manganese oxide with a high discharge capacity can be obtained by using the lithium-containing precursor and the manganese-containing precursor that were pulverized in a solvent.

Thus, according to the present invention, a lithium-manganese oxide having a discharge capacity can be obtained by setting the full width half maximum of the peak of the (001) crystal plane to 0.22° or greater and setting the average particle size to 130 nm or less.

### EXPERIMENT 2

### Preparation of Positive Electrode Active Material

### Example 7

Lithium hydroxide (LiOH.H₂O), manganese carbonate (MnCO₃.nH₂O (n: about 0.5)) and aluminum hydroxide (Al(OH)₃) were mixed so that the mole ratio of Li:Mn:Al became 2:0.98:0.02. The mixture was added in acetone and pulverized in acetone for 1 hour using a ball mill. Thereafter, the mixture was dried at 60° C. to volatilize acetone, and the pulverized mixture, without being pelletized, was annealed under the annealing conditions set forth in Table 4. The annealing was performed at 425° C. for 10 hours, as set forth in Table 4.

### Example 8

Lithium hydroxide (LiOH.H₂O), manganese carbonate (MnCO₃.nH₂O (n: about 0.5)) and titanium hydroxide (Ti(OH)₄) were mixed so that the mole ratio of Li:Mn:Ti became 2:0.95:0.05. The mixture was added in acetone and pulverized in acetone for 1 hour using a ball mill. Thereafter, the mixture was dried at 60° C. to volatilize acetone, and the pulverized mixture, without being pelletized, was annealed under the annealing conditions set forth in Table 4. The annealing was performed at 425° C. for 10 hours, as set forth in Table 4.

### Example 9

Lithium hydroxide (LiOH.H₂O), manganese carbonate (MnCO₃.nH₂O (n: about 0.5)) and boric acid (H₃BO₃) were mixed so that the mole ratio of Li:Mn:B became 1.99:0.98:0.03. The mixture was added in acetone and pulverized in acetone for 1 hour using a ball mill. Thereafter, the mixture was dried at 60° C. to volatilize acetone, and the pulverized mixture, without being pelletized, was annealed under the annealing conditions set forth in Table 4. The annealing was performed at 425° C. for 10 hours, as set forth in Table 4.

### Example 10

Lithium hydroxide (LiOH.H₂O), manganese carbonate (MnCO₃.nH₂O (n: about 0.5)) and magnesium hydroxide (Mg(OH)₂) were mixed so that the mole ratio of Li:Mn:Mg became 2:0.98:0.02. The mixture was added in acetone and pulverized in acetone for 1 hour using a ball mill. Thereafter, the mixture was dried at 60° C. to volatilize acetone, and the pulverized mixture, without being pelletized, was annealed under the annealing conditions set forth in Table 4. The annealing was performed at 600° C. for 10 hours, as set forth in Table 4.

### Examples 11 and 12

Lithium hydroxide (LiOH.H₂O), manganese carbonate (MnCO₃.nH₂O (n: about 0.5)) and lithium fluoride (LiF) were mixed so that the mole ratio of Li:Mn:F became 2:1:0.04 (Example 11) or 2:1:0.08 (Example 12). The mixtures were added in acetone and pulverized in acetone for 1 hour using a ball mill. Thereafter, the mixtures were dried at 60° C. to volatilize acetone, and the pulverized mixtures, without being pelletized, were annealed under the annealing conditions set forth in Table 4. The annealing was performed at 425° C. for 10 hours, as set forth in Table 4.

### Examples 13 to 18

Lithium hydroxide (LiOH.H₂O), manganese carbonate (MnCO₃.nH₂O (n: about 0.5)) and cobalt nitrate (Co(NO₃)₂) were mixed so that the mole ratio of Li:Mn:Co became 1.95:0.9:0.15 (Examples 13 and 16), 1.9:0.8:0.3 (Examples 14 and 17), or 1.85:0.7:0.45 (Examples 15 and 18). The mixtures were added in acetone and pulverized in acetone for 1 hour using a ball mill. Thereafter, the mixtures were dried at 60° C. to volatilize acetone, and the pulverized mixtures, without being pelletized, were annealed under the annealing conditions set forth in Table 4. The annealing was performed at 600° C. for 10 hours (Examples 13 to 15) or 750° C. for 10 hours (Examples 16 to 18), as set forth in Table 4.

### Measurement of the Full Width Half Maximum of a Peak by an X-Ray Diffraction Analysis

The X-ray diffraction profiles of the resultant positive electrode active materials were measured. The full width half maximum of the peak of the (001) crystal plane, i.e., the peak at about 18.7°, were measured. The results are shown in Table 4.

### Measurement of Average Particle Size

The average particle sizes of the resultant positive electrode active materials were determined by SEM observation. The results of the measurement are shown in Table 4 below.

### Preparation of Lithium Secondary Battery

Using the resultant positive electrode active materials, positive electrodes were prepared in the same manner as described in the foregoing, and using the prepared positive electrodes, lithium secondary batteries were fabricated. The discharge capacities of the lithium secondary batteries were measured. The results of the measurement are shown in Table 4 below.

TABLE 4

| | | | | | full width | | |
|---|---|---|---|---|---|---|---|
| | | | | | half | | |
| | | | | | maximum | Average | |
| | | | | | of peak at | particle | Discharge |
| | | Element | Chemical | | 18.7° | size | capacity |
| | Pulverization | added | formula | Annealing | (001) | (nm) | (mAh/g) |
| Ex. 7 | Pulverized in | Al | Li₂Mn_{0.98}Al_{0.02}O₃ | 425° C., | 0.379 | 72 | 233.1 |
| | solvent | | | 10 hrs. | | | |
| Ex. 8 | Pulverized in | Ti | Li₂Mn_{0.95}Ti_{0.05}O₃ | 425° C., | 0.365 | 78 | 231.0 |
| | solvent | | | 10 hrs. | | | |
| Ex. 9 | Pulverized in | B | Li_{1.99}Mn_{0.98}B_{0.03}O₃ | 425° C., | 0.407 | 75 | 237.4 |
| | solvent | | | 10 hrs. | | | |
| Ex. 10 | Pulverized in | Mg | Li₂Mn_{0.98}Mg_{0.02}O₃ | 600° C., | 0.376 | 72 | 240.8 |
| | solvent | | | 10 hrs. | | | |
| Ex. 11 | Pulverized in | F | Li₂MnO_{2.96}F_{0.04} | 425° C., | 0.39 | 76 | 268.5 |
| | solvent | | | 10 hrs. | | | |
| Ex. 12 | Pulverized in | F | Li₂MnO_{2.92}F_{0.08} | 425° C., | 0.395 | 85 | 265.9 |
| | solvent | | | 10 hrs. | | | |
| Ex. 13 | Pulverized in | Co | Li_{1.95}Mn_{0.9}Co_{0.15}O₃ | 600° C., | 0.475 | 78 | 272.1 |
| | solvent | | | 10 hrs. | | | |
| Ex. 14 | Pulverized in | Co | Li_{1.9}Mn_{0.8}Co_{0.3}O₃ | 600° C., | 0.48 | 82 | 258.5 |
| | solvent | | | 10 hrs. | | | |
| Ex. 15 | Pulverized in | Co | Li_{1.85}Mn_{0.7}Co_{0.45}O₃ | 600° C., | 0.599 | 87 | 228.2 |
| | solvent | | | 10 hrs. | | | |
| Ex. 16 | Pulverized in | Co | Li_{1.95}Mn_{0.9}Co_{0.15}O₃ | 750° C., | 0.263 | 109 | 216.8 |
| | solvent | | | 10 hrs. | | | |
| Ex. 17 | Pulverized in | Co | Li_{1.9}Mn_{0.8}Co_{0.3}O₃ | 750° C., | 0.320 | 100 | 212.7 |
| | solvent | | | 10 hrs. | | | |
| Ex. 18 | Pulverized in | Co | Li_{1.85}Mn_{0.7}Co_{0.45}O₃ | 750° C., | 0.382 | 101 | 218.1 |
| | solvent | | | 10 hrs. | | | |

As shown in Table 4, the lithium-manganese oxides containing the additional elements according to the present invention also achieved high discharge capacities.

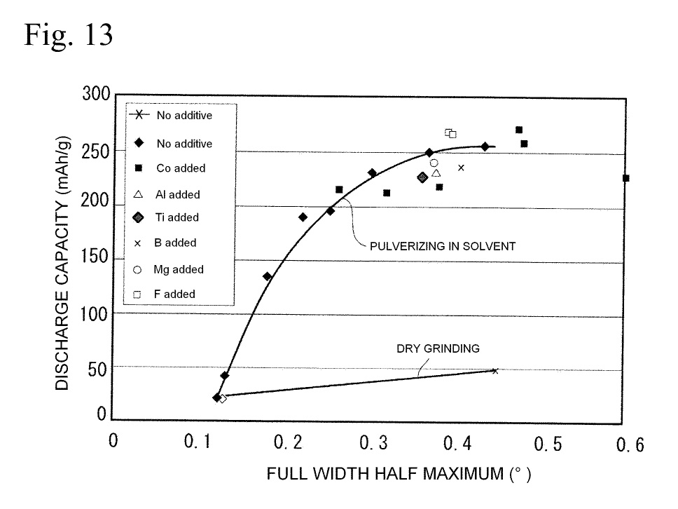

FIG. 13 is a graph illustrating the relationship between the full width half maximum and the discharge capacity. As seen from FIG. 13, a lithium-manganese oxide having a high discharge capacity can be obtained by using the lithium-containing precursor, the manganese-containing precursor, and the additional element-containing precursor that were dispersed in a solvent.

The foregoing examples show lithium secondary batteries using metallic lithium as the negative electrode. However, the present invention is not limited to such lithium secondary batteries.

1. A positive electrode active material for lithium secondary batteries, comprising a layered lithium-manganese oxide represented by the general formula Li₂₋ₓMn_{1-y}O₃₋ₚ, where 0≦x≦2/3, 0≦y≦1/3, and 0≦p≦1, the lithium-manganese oxide having a full width half maximum of a peak of the (001) crystal plane, as determined by an X-ray diffraction analysis, of 0.22° or greater, and an average particle size of 130 nm or less.

2. The positive electrode active material according to claim 1, wherein the lithium-manganese oxide is represented by the formula Li₂MnO₃ or Li[Li_{0.33}Mn_{0.67}]O₂.

3. A positive electrode active material for lithium secondary batteries, comprising a layered lithium-manganese oxide represented by the general formula Li₂₋ₓMn_{1-y}M_{z}O₃₋ₚF_{q}, where 0≦x≦0.3, 0≦y≦0.3, 0≦z≦0.5, 0≦p≦0.1, 0≦q≦0.1, wherein M is at least one element selected from the group consisting of Al, B, Ti, Mg, and Co, the layered lithium-manganese oxide having a full width half maximum of a peak of the (001) crystal plane, as determined by an X-ray diffraction analysis, of 0.22° or greater, and an average particle size of 130 nm or less.

4. The positive electrode active material for lithium secondary batteries according to claim 1, wherein the full width half maximum is 0.30° or greater, and the average particle size is 90 nm or less.

5. The positive electrode active material for lithium secondary batteries according to claim 3, wherein the full width half maximum is 0.30° or greater, and the average particle size is 90 nm or less.

6. The positive electrode active material for lithium secondary batteries according to claim 1, wherein the lithium-manganese oxide has a BET specific surface area of 9 m²/g or greater.

7. The positive electrode active material for lithium secondary batteries according to claim 3, wherein the lithium-manganese oxide has a BET specific surface area of 9 m²/g or greater.

8. The positive electrode active material for lithium secondary batteries according to claim 6, wherein the lithium-manganese oxide has a BET specific surface area of 15 m²/g or greater.

9. The positive electrode active material for lithium secondary batteries according to claim 7, wherein the lithium-manganese oxide has a BET specific surface area of 15 m²/g or greater.

10. A method of manufacturing a positive electrode active material for lithium secondary batteries according to claim 1, comprising the step of:
producing the positive electrode active material by a solid phase method using
a lithium-containing precursor and a manganese-containing precursor each having a reaction temperature of 500° C., and optionally,
an additional element-containing precursor.

11. A method of manufacturing a positive electrode active material for lithium secondary batteries according to claim 3, comprising the step of
producing the positive electrode active material by a solid phase method using
a lithium-containing precursor and a manganese-containing precursor each having a reaction temperature of 500° C., and optionally,
an additional element-containing precursor.

12. The method according to claim 10, wherein the lithium-containing precursor is lithium hydroxide or lithium nitrate.

13. The method according to claim 11, wherein the lithium-containing precursor is lithium hydroxide or lithium nitrate.

14. The method according to claim 10, wherein the manganese-containing precursor is manganese carbonate.

15. The method according to claim 11, wherein the manganese-containing precursor is manganese carbonate.

16. The method according to claim 10, further comprising pulverizing the lithium-containing precursor, the manganese-containing precursor, and if present, the additional element-containing precursor, in a solvent, and thereafter producing the positive electrode active material by a solid phase method.

17. The method according to claim 11, further comprising pulverizing the lithium-containing precursor, the manganese-containing precursor, and if present, the additional element-containing precursor, in a solvent, and thereafter producing the positive electrode active material by a solid phase method.

18. The method according to claim 16, wherein the solvent is acetone.

19. The method according to claim 17, wherein the solvent is acetone.

20. A lithium secondary battery comprising a negative electrode, a non-aqueous electrolyte, and a positive electrode containing a positive electrode active material according to claim 1.
